(19) United States
(12) Patent Application Publication
(10) Pub. No.: US 2009/0293705 A1
(43) Pub. Date: Dec. 3, 2009

(54) MOBILE MUSICAL GAMING WITH INTERACTIVE VECTOR HYBRID MUSIC

(75) Inventors: Moshe Vered, Kiryat-Ono (IL); Ehud Lavski, Herzlia (IL)

Correspondence Address: KEVIN D. MCCARTHY;ROACH BROWN MCCARTHY & GRUBER, P.C., 424 MAIN STREET, 1920 LIBERTY BUILDING, BUFFALO, NY, 14202, US

(73) Assignee: SAMSUNG ELECTRONICS CO., LTD., Gyeonggi-do (KR)

(21) Appl. No.: 12/131,166

(22) Filed: Jun. 2, 2008

(51) Int. Cl. G10H 7/00; A63F 9/24

(52) U.S. Cl. 84/609; 84/645; 463/7

(57) ABSTRACT

A method for interacting with music on a mobile device comprises actuating by a user vector music which is overlaid on streaming music.

### FIELD OF THE INVENTION

The present invention relates to the field of digital music. More particularly, the invention relates to methods for allowing the user of a handheld device, particularly a cellular phone, to interact with music on his device.

### BACKGROUND OF THE INVENTION

Modern handheld devices are equipped with music systems, which allow a user to play prerecorded streams of music, and also to generate musical notes and sequences thereof. As a result, a need has arisen to allow users of handheld devices to efficiently interact with music being played and/or generated on the device. Several musical games have been developed in the art in an attempt to meet this demand.

Music/Rhythm games are a genre of game in which a user interacts with a piece of music. The user has to press a button or perform a game action along with the music's notes/beats. Music games essentially belong to two categories:

### 1. Music Playing Games

In these games the user plays a simulated musical instrument either via a standard console/PC controller or through a dedicated controller which mimics a musical instrument. Another variation is one in which the user is asked to sing in his own voice through a microphone.

These games usually involve a prerecorded background music track for all music but the instrument being played, and another track for the instrument itself. In case of singing games the user's voice is fed into the game through a microphone.

Guitar hero is a game in which a user plays guitar using a special guitar controller. The music is composed of one track comprising all prerecorded instruments and voices except for the guitar, and another track for the guitar only.

Rock band is a game in which 4 players play as a band using guitar, bass, drum and microphone peripherals. There are tracks for each instrument that combine to create the music.

Singstar is a game in which the user sings along with a song through a microphone and is graded on his performance. The original recorded song plays as it is and the user's voice is heard along with the original singer's. Several other similar games are known in the art, which are not described herein in detail, for the sake of brevity.

### 2. Rhythm-Based Games

In these games the music is prerecorded and the user needs to hit a button on a controller/dedicated peripheral at a time which corresponds to a specific beat/note. In these games the user does not have any control over the actual music being played and his success or failure to hit a note is indicated by a sound or a graphic.

Illustrative examples of such games include “Dance Dance Revolution”, a game in which a song plays and the user needs to press a button corresponding to a beat/note. The game can be played on a standard game controller or using a dance mat controller. The user's action do not change the prerecorded music. Other popular games of this type, which is are not described herein for the sake of brevity, are DJ Max and Dance Factory. In these games also the user's action do not change the prerecorded music.

Music games on mobile phone tend to use one of two solutions, each of which is limited in what it provides.

1) Synthesizer-Based Live Music

This is a solution used for its small file size and the freedom of playing a live instrument. Its disadvantage is a cold, mechanical sound that does not provide the user with a rich sound experience. Illustrative examples of games using this method include “Guitar Legends”, which uses synthesizer-based live music to recreate the experience of playing a guitar but does not provide a rich sound experience. Similar results are obtained with “Dance Revolution Mobile”, “Groove Fever” and “Taiko Drum Master”.

2) Prerecorded Music.

The solution offers richer, more realistic sounding music and the ability to include human voices. Its disadvantages are prohibitively large file sizes and the lack of freedom that comes with a sound or piece of music which is pre-recorded. This approach is used, for instance, in the game “DJ Max”, in which a song plays and the user needs to press a button corresponding to a beat/note. The user's actions do not change the prerecorded music.

Therefore, there is a need for a solution which allows for small file size that can be utilized in mobile equipment and, at the same time, gives the freedom of playing actual synthesizer-based music while maintaining the richer, more realistic sound of prerecorded music and allowing for the inclusion of human singing voice.

It is therefore an object of the present invention to provide a method and system which overcome the deficiencies of the prior art.

Other objects of the invention will become apparent as the description proceeds.

### SUMMARY OF THE INVENTION

In one aspect the invention relates to a method for interacting with music on mobile device, comprising actuating by a user vector music which is overlaid on streaming music.

According to one embodiment of the invention the vector music is MIDI. According to another preferred embodiment of the invention the streaming music is selected from PCM and MP3 or other suitable formats.

According to still another embodiment of the invention a synthesizer is used to synchronize the playing of the vector and streaming music. Preferably, but not limitatively, the mobile device is a cellular phone.

The invention also encompasses a musical game playable on a mobile device, comprising vector music actuatable by a user so it is overlaid on streaming music. In a preferred embodiment of the invention, when the user presses the phone key pad correctly, a specific note/accord is played and sounds essentially the same as if playing a real musical keyboard. Other options include a situation in which when the user does not press a key the specific note/accord connected to the game, it is not heard, or when the user plays an incorrect key, an “out-of-tune” musical note is heard to emphasize the user's failure.

### BRIEF DESCRIPTION OF THE DRAWINGS

In the drawings:

FIG. 1 schematically illustrates the correspondence of streaming music and a MIDI vector;

FIG. 2 schematically shows how the sequence of a vector generated by a synthesizer and a musical stream can start at the same time;

FIG. 3 schematically shows the data flow into the mobile device; and

FIG. 4 shows the states that need to be supported in the example to follow.

### DETAILED DESCRIPTION

The invention solves of the problems present in prior art systems by using vector music (e.g., MIDI) which is overlaid on streaming music (e.g. PCM or MP3). By using both methods on mobile equipment the invention exploits the richness of recorded music (e.g. vocals) using stream-like methods and, at the same time, the flexibility of vector music (e.g. specific instrument notes), which allows full interaction with a player (i.e., the user).

In an illustrative system according to a preferred embodiment of the invention the inventors have carried out the invention with the following elements:

The standard architecture allows either MP3 or MIDI to be played individually and not at the same time. In order to achieve the “working together”, simultaneous playing, a synthesizer was used in addition to the MP3 decoding. According to a preferred embodiment of the invention the synthesizer is provided in hardware form and is chip-based, which allows for easy handling of both the synthesizer and the MP3 decoder by the CPU. It should be noted that prior art methods and games based thereon do not employ or require an additional synthesizer. That's, a different opened a constructor of the system is implemented in order to carry out the invention according to this preferred embodiment thereof.

Where in this description reference is made to “phone” or “cellular phone”, it is meant to refer to, and to encompass within the scope of this invention, all mobile devices that can be used for the purposes of invention, including but not limited to cellular phones, PDAs, gaming equipment, etc.

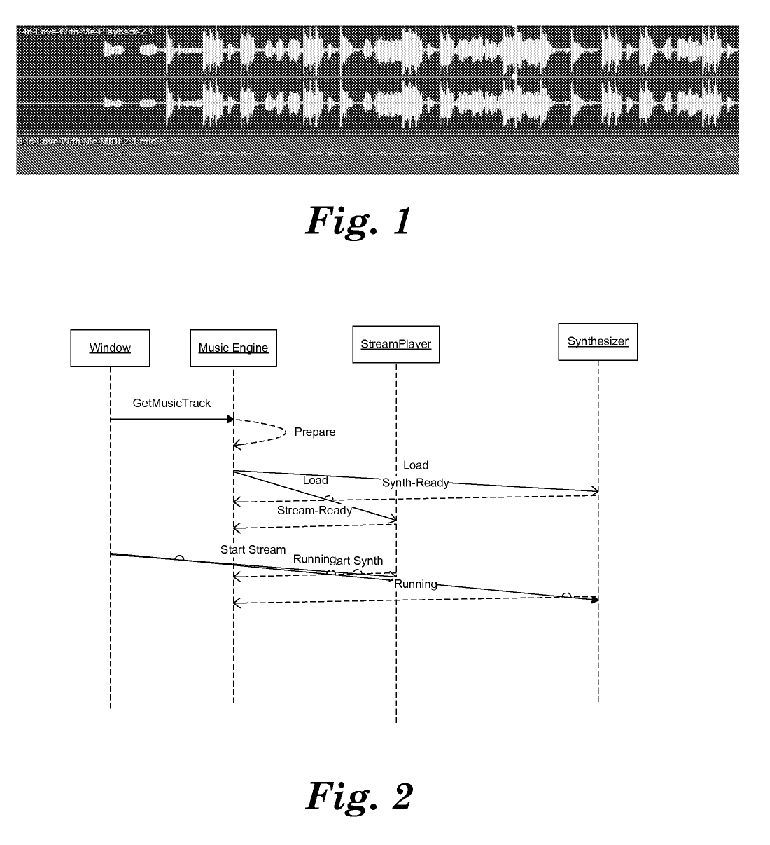

FIG. 1 shows the correspondence of music originating from a streamed file (top) and synthesized into a vector (MIDI—bottom).

The use of an additional synthesizer enhances the musical instrument playing experience in the following manner: When the user presses the phone key pad correctly, a specific note/accord is played and sounds the same as if playing a real musical keyboard. This is because according to the invention full control is achieved over the music that the user plays. This means that the user experience is very much similar to real play. For example, it is possible to shorten the musical notes if the player presses the keys for too short a time, which creates another interaction that is closer to “real playing”.

When the user does not press a key the specific note/accord connected to the game, is not heard, due to the fact that the synthesizer is not given the specific note to be played.

When the user plays an incorrect key, an “out-of-tune” musical note is heard to emphasize the user's failure.

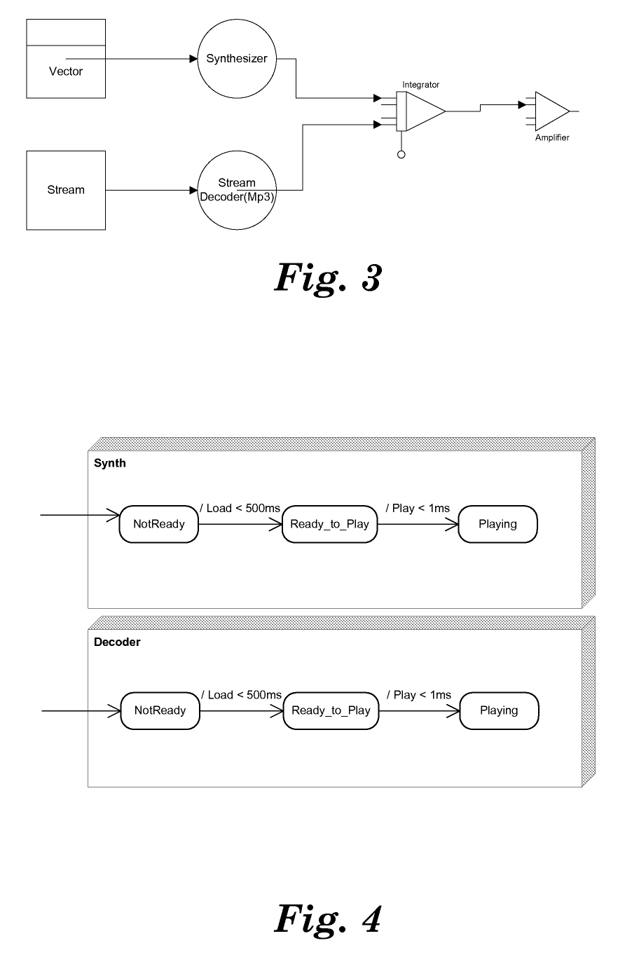

Since the space on mobile handsets is very limited, it is preferred to use MIDI as the base format for holding the vector musical and the gaming data, and MP3 as the format for the streaming music, which is compressed. On the implementation the MIDI (vector) synthesizer and MP3 (stream) decoder or played using different mechanisms. The MIDI data also showed have at least one delayed start parameter to adjust to the start time of playing of the streaming buffering, depending on the module buffering that plays the stream. The skilled person will easily select the appropriate parameters needed to achieve such synchronization. In the synchronization of the sequence of vector and stream is illustrated in FIG. 2. The flow of data into the mobile device is schematically showing in FIG. 3.

In view requirements from the MP3 and MIDI players in the exemplary system was the following:

Each player needed an operational state (e.g. READY TO PLAY), which allows for a precise and short period of time (less than half a second). This requirement is illustrated in FIG. 4. Therefore, the MP3 loading and buffering, when starting to play, should take (in this particular embodiment of the invention) always a constant time (e.g., 120 milli-seconds), no more no less, and then when playing the MIDI, the synthesizer should start playing immediately, preferably after no more than 1 milli-second. The reason for this preference is that the jitter for musical ear can be less than a beat of the highest rate, which is 208 bpm, which in turn translates to less than ˜4.8 ms. If one wanted to create, for instance, a “band” of 4 players, which each has a jitter, this can sum up to 4 ms (if each has at most 1 a ms jitter).

Another assumption that is taken into account is that both playing mechanisms remain accurate (i.e., do not lose more than 5 ms during all the playing time). In the case of changing play rate a precise progress clock and telemetries must be provided, that work in the milli-second precision range, so that the vector music can be fixed and can realign to the current rate of play. As will be apparent to persons skilled in the art, Some mp3 players can exhibits inconsistent play rates, or even data loss, and yet a human ear will not send us such “musical” defects.

### EXAMPLE

This example illustrates how the MIDI can hold both musical and game sequences: The content consists the following Darts:

Music part and Game sequence.

The Game sequence relies on the Music sequence (MIDI), but can be based on any note.

### 1. Music Part

1.1.MP3 file (stream) and at least 4 MIDI tracks (vector) that represent 4 parts of roles in music (drum, base, guitar and keyboard/misc/lead) Additional MIDI channels can be added to enhance the musical feel by remixing each additional channel for each playing role.

MP3: of any bit rate—depending on the limitation of the specific mobile device involved.

MIDI: type 1. Based on General Midi, with up to 11 channels.

2.2. Expected length of music: about 2 minutes.

### 2. Game Part

Should make the player “feel” like playing music.

Each Music Part will come with 4 Game Sequences with accordance to guitar, drums, base, keyboard/lead which will be created according to music and game-play.

Each game sequence is a midi channel for which each note (musical key and velocity) is converted to a key press expected and the musical channel that is actuated by the correct or incorrect user key pressing. The correlation to a specific note on the musical part, is done by synchronizing on the tick count (i.e., the atomic units in MIDI).

As will be apparent to persons skilled in the art from the description given above, the method of the invention provides a convenient and efficient solution to the problems and drawbacks of the prior art. It takes vector music, which takes up around 10-100 KB per song, and a compressed stream stereo-phone musical channel. The storage place takes up close the storage of a stream based musical game, but has the flexibility of a vector music.

Additionally, using vector music it is possible to hold as many channels as needed for gaming. furthermore, using the method of the invention it is possible to make the music sound differently on each game role or difficulty level.

The above description and example have been provided for the purpose of illustration and are not meant to limit the invention in any way. Many different implementations of the invention can be provided, using different mobile devices, without departing from the spirit of the invention.

1. A method for interacting with music on a mobile device, comprising actuating by a user vector music which is overlaid on streaming music.

2. A method according to claim 1, wherein the vector music is MIDI.

3. A method according to claim 1, wherein the streaming music is selected from PCM and MP3 or other suitable formats.

4. A method according to claim 1, wherein a synthesizer is used to synchronize the playing of the vector and streaming music.

5. A method according to claim 1, wherein the mobile device is a cellular phone.

6. A musical game playable on a mobile device, comprising vector music actuatable by a user so it is overlaid on streaming music.

7. A game according to claim 6, wherein when the user presses the phone key pad correctly, a specific note/accord is played and sounds essentially the same as if playing a real musical keyboard.

8. A game according to claim 6, wherein when the user does not press a key the specific note/accord connected to the game, it is not heard.

9. A game according to claim 6, wherein when the user plays an incorrect key, an “out-of-tune” musical note is heard to emphasize the user's failure.

10. A game according to claim 6, which utilizes an additional synthesizer.
